(19) United States
(12) Patent Application Publication
(10) Pub. No.: US 2026/0195305 A1
(43) Pub. Date: Jul. 9, 2026

(54) REVERSE SYNCHRONIZATION ASSOCIATED WITH DATA MIGRATION

(71) Applicant: Wells Fargo Bank, N.A., San Francisco, CA (US)

(72) Inventors: Stephen William Abernathy, JR., San Bruno, CA (US); Mudassar Najmuddin Bala, Livermore, CA (US); Yayati Prakash Deshpande, San Ramon, CA (US); Sateesh Kumar Gogineni, Concord, NC (US); Lipsa Goswamy, Oakland, CA (US); Steve Hagerman, Charlotte, NC (US); Sanjeev Karigowdanakoppalu, Corte Madera, CA (US); Pankaj Mishra, Cary, NC (US); Ananthakrishna Parampalli, Danville, CA (US); Veera Venkata Ramesh Tamma, Mountain House, CA (US)

(21) Appl. No.: 19/009,095

(22) Filed: Jan. 3, 2025

(51) Int. Cl. G06F 16/21

(52) U.S. Cl. CPC G06F 16/214

(57) ABSTRACT

An example computer system for reverse synchronization of migrated data can include: one or more processors; and non-transitory computer-readable storage media encoding instructions which, when executed by the one or more processors, causes the computer system to: consume a change stream from a target data store, the change stream including the changed data; transform the changed data in the change stream from a target format to a source format; and write the source format in a source data store. ; and switching a customer of the computer system from the target data store to the source data store in case on a contingency.

### RELATED APPLICATION(S)

This patent application relates to Application Number Ser. No. 18/302,485 filed on Apr. 18, 2023, the entirety of which is hereby incorporated by reference.

### BACKGROUND

As part of modernization or migration to more newer technologies (e.g., microservices and/or the cloud), existing applications may move away from legacy technology stacks (e.g., monolith, relational data store management systems) to modern technology stacks (e.g., microservice, document data store or column data store). One typical prerequisite to performing this migration is transferring the associated data from one data store to another.

### SUMMARY

Examples provided herein are directed to reverse synchronization associated with data migration.

According to one aspect, an example computer system for reverse synchronization of migrated data can include: one or more processors; and non-transitory computer-readable storage media encoding instructions which, when executed by the one or more processors, causes the computer system to: consume a change stream from a target data store, the change stream including the migrated data; transform the migrated data in the change stream from a target format to a source format; write the source format in a source data store; and switch a customer of the computer system from the target data store to the source data store, (in case contingency needs to be exercised).

According to another aspect, an example method for reverse synchronization of migrated data can include: consuming a change stream from a target data store of a computer system, the change stream including the migrated data; transforming the migrated data in the change stream from a target format to a source format; writing the source format in a source data store; and switching a customer of the method from the target data store to the source data store, (in case contingency needs to be exercised).

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 shows an example system for migrating data from a source data store to a target data store.

FIG. 2 shows an example a reverse data sync connector of FIG. 1 performing reverse synchronization.

FIG. 3 shows multiple data centers of the system of FIG. 1.

FIG. 4 shows additional details of an example reverse data sync connector of the migration device of FIG. 2.

FIG. 5 shows example physical components of the migration device of the system of FIG. 1.

### DETAILED DESCRIPTION

This disclosure relates to reverse synchronization associated with data migration.

Examples described herein provide for migration of data between source (legacy) and target (new) data stores. This can include an example distributed event-based data migration and validation framework that migrates data from the source data store to the target data store in near real-time and/or reconciles the data in near real-time after successful data migration. This can also involve near real-time validation for successfully migrated and/or synchronized data.

As data is migrated, problems can arise. As a fail-over, customers who have already been migrated can be switched back to the legacy system without the loss of data. To accomplish this functionality, reverse data synchronization is provided, which is implemented between the legacy data store (e.g., an Oracle database from Oracle Corporation) and the target data store (e.g., a MongoDB database from MongoDB, Inc.). The reverse data synchronization can be implemented as a low latency (e.g., less than 5 seconds), highly resilient, almost real time ecosystem with high availability developed to maintain data synchronization between the legacy and target data stores.

There can be various advantages associated with the technologies described herein.

For instance, as failures occur with migration, customers can be switched between the target (new) and source (legacy) systems, which minimizes downtime. This results in a seamless experience for the customers and the practical application of a more robust system with greater uptime. Many other advantages are possible.

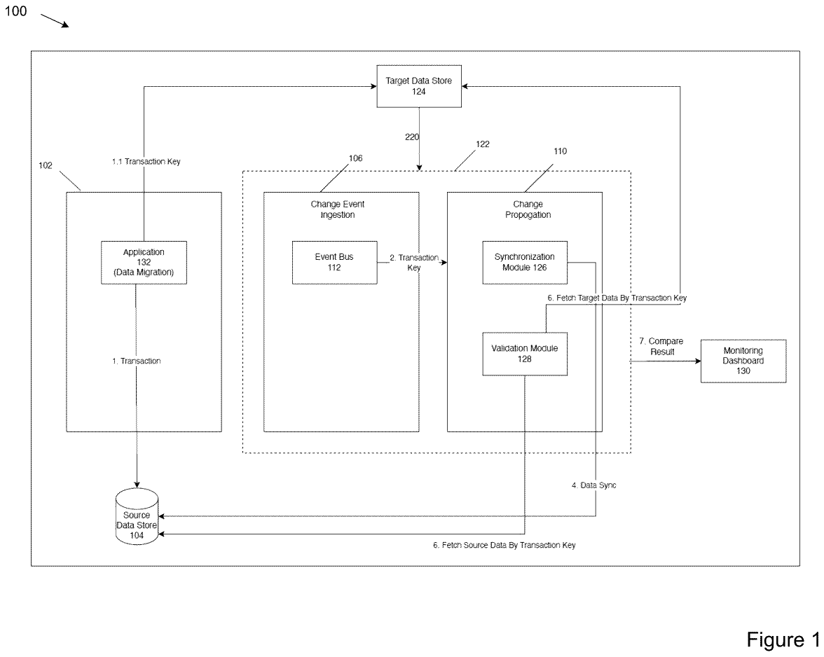

FIG. 1 schematically shows aspects of one example system 100 programmed to migrate data and perform reverse synchronization of migrated data back to legacy source datastore. The system 100 can be a computing environment that includes a plurality of client and server devices. In this instance, the system 100 includes client device (migration component) 102, a synchronization device 122, data stores-104, 124, and a monitoring dashboard 130. The client device 102, the synchronization device 122, the data stores 104, 124, and the monitoring dashboard 130 can communicate through a network to accomplish the functionality described herein.

Each of the devices of the system 100 may be implemented as one or more computing devices with at least one processor and memory. Example computing devices include a mobile computer, a desktop computer, a server computer, or other computing device or devices such as a server farm or cloud computing used to generate or receive data. Although only a few devices are shown, the system 100 can accommodate hundreds or thousands of computing devices.

The example data stores 104, 124 are programmed to store information about the processes of the system 100. As described further herein, the data store 104 functions as the source data store, and the data store 124 functions as the target data store.

The example architecture of the system 100 can be highly extensible to support different data stores. In some examples, the data stores supported include Oracle and MongoDB. However, the system 100 can be extended to support other types of data stores. Further, the system 100 can handle large volumes of data from the data stores 104, 124. This allows the system 100 to be scalable and address different technology choices.

The system 100 is programmed as described herein to migrate data from the data store 104 to the data store 124. This migration is initiated by copying a portion and/or all the data from the data store 104 to the data store 124. As described below, as this migration is taking place, changes made to the data are captured so that the data in the data stores 104, 124 is maintained in a current state.

In the example depicted in FIG. 1, an application 132 on the client device 102 accesses data from the data store 104 through an Application Programming Interface (API) or other mechanism to perform various functions associated with an enterprise. For instance, the system 100 can provide financial services, and the client device 102 can be programmed to access data from the data store 104 to facilitate those financial services.

In some examples, the application 132 of the client device 102 is programmed to transition from accessing data from the data store 104 to accessing data from the data store 124 (suggestion on verbiage for underlined-writing data to data store 124) as the data is migrated from the data store 104 to the data store 124. In other examples, the data is migrated in stages, so the client device 102 can, at some point, access data from either the data store 104 or the data store 124 for at least a period of time during the migration process.

In general, as the synchronization device 122 interacts with the data store 124, data that is changed is captured as events by a change event ingestion module 106 of the synchronization device 122. These events are published to the synchronization device 122 to allow synchronization of the data between the data store 124 and the data store 104. To accomplish this publication, the data and associated metadata, including a transaction key, are provided to a change event ingestion bus 112 of the change event ingestion module 106 for each transaction by the client device 102.

In the examples provided herein, the transaction key is a unique identifier of data stored in the data store 104 and the data store 124. The transaction key can, for instance, be a globally unique identifier (e.g., a value having a certain length) that can be used to identify data. For instance, the transaction key can be a unique number that is used to identify data stored in the source data store and the target data store so that the data can be compared for synchronization and validation, as described further below. Many other configurations are possible.

In one example, the events are captured as JavaScript Object Notation (JSON) events. The change event ingestion module 106 receives the events, including the associated transaction keys, as the events are published by the synchronization module 126 running on the change propagation module 110. More specifically, as other applications (e.g., microservices) manipulate data within the data store 124, the data store 124 also publishes events to the change event ingestion bus 112 of the change event ingestion module 106. The change event ingestion module 106, in turn, extracts the data changes from the events and provides the event and data information to a change propagation module 110 of the synchronization device 122, which is described further below.

Generally, the synchronization device 122 receives the events from the change event ingestion module 106 and assures that the data in the data stores 104, 124 is kept synchronized. For instance, when an event indicating a change at the data store 124 is received by the synchronization device 122, the synchronization device 122 applies a transformation and saves the changes to the data store 104. The transformation can be configurable for each event. Adding or modifying the configuration for an event can be done by adding required configuration parameters. This makes the synchronization device 122 extensible and adaptable for future data migrations.

As the data changes are captured and migrated in near real-time by the application 132, switching or rolling out the traffic to the new system becomes seamless and allows the rollout to be carried out in phased manner. These events, after migrating the data to data store 124, can also be sampled and sent for validation by the validation module 128, as described below. If there is any intermittent failure, then retry happens to fix the issue automatically.

More specifically, as the change event ingestion bus 112 receives events, these events are provided to the change propagation module 110. The change propagation module 110 includes a synchronization module 126 and a validation module 128.

The example synchronization module 126 of the change propagation module 110 is programmed to receive the data associated with each event from the change event ingestion bus 112, apply any necessary transformations to the data, and synchronize the transformed data with the data store 104.

The synchronization module 126 uses various transformation logic to transform the data that is being changed. For instance, the following transformations can be applied on the data captured from the data store 124 in sequence.

Deduplication of event—each event is identified by a unique identifier and processed once. The change propagation module 110 can be distributed across multiple clusters, and it is possible that more than one instance of the change propagation module 110 picks up the same event. Because of idempotency, regardless of how many times the same change event is being received, synchronization module 126 processes only once, based on processing time stamp.

Stale Filter—each event is checked for staleness before it is updated in the data store 104. If the data store 104 has the latest changes compared to the data present in the event, the event is ignored. The event is updated only when the data present in the event or the data fetched from the data store 124 is the latest compared to the source data store.

Field Mapping—for each event, there may be a set of fields that needs to be mapped from the data store 104 to the data store 124. The field mapping helps in migrating the data from the source to the target data store.

Data Type—the change propagation module 110 performs the data type transformation if a source data model of the data store 104 requires a field data type to be modified to another.

Custom Processing—the change propagation module 110 also supports custom processing. The change propagation module 110 can be extended to add the custom processing logic.

Sampling for validation—the change propagation module 110 provides the flexibility for sampling the records for validation by the validation module 128. If the sampling is set to 0 percent, then no events are validated. If the sampling is set to 10 percent, then 10 percent of the events are sent for validation by the validation module 128. The validation module 128 processes the sampled events and performs the comparison of fields between source and target data stores, as described further below.

In the examples provided herein, the change propagation module 110 of the client application 132 is programmed to control how much data is migrated from the data store 104 to the data store 124. For instance, a subset of the data in the data store 104 can be selected to be migrated. For instance, a user can select certain subset(s) of data to be migrated to the data store 124 by the client application 132, while leaving other data stored in the data store 104. In one instance, a flag is used to turn migration on and off, although many other configurations are possible.

In another embodiment, the change propagation module 110 of the synchronization device 122 is programmed to provide a dynamic increase and/or decrease in an amount of data synchronized. For instance, in addition to selection of a subset of data for synchronization, one can select a percentage of data to be synchronized. In one instance, the application 132 can be used to program the increase and/or decrease in the amount of data, although many configurations are possible.

In one example, the change propagation module 110 is programmed to allow for the gradual rollout of data migration based upon the amount of increase or decrease defined by the application 132. In this instance, the change propagation module 110 is programmed to start with a small percentage of data that is migrated to the data store 124, such as 1 percent. The change propagation module 110 thereupon controls the percentage of the data that is migrated, gradually increasing the amount over time. For instance, the amount of data that is migrated can be gradually increase to 10 percent, 50 percent, and finally 100 percent.

For instance, the change propagation module 110 can be programmed to start with a small percentage of data that is synchronized. After a set time interval, such as one hour, five hours, 10 hours, 1 day, or 7 days, the change propagation module 110 can be programmed to increase the percentage. Over time, the percentage can continue to be increased until a desired percentage is reaches, such as 100 percent.

This gradual rollout of migration can be used to minimize the impact on customers and can be used to assure there are no problems with the synchronization. If problems are identified (e.g., by the validation module 128 described below), the change propagation module 110 can halt and/or reverse the migration of the data from the data store 124 to the data store 104 (as described below). In one instance, a flag is used to control the percentage of data that is synchronized, although many other configurations are possible.

For example, the change propagation module 110 of the synchronization device 122 is programmed to allow for reverse synchronization of data. In other words, data can be synchronized from the data store 124 to the data store 104. This is accomplished in part through the ability to define subsets of data that are synchronized (e.g., target data store syncs data 1-100; source data store syncs data 101-200).

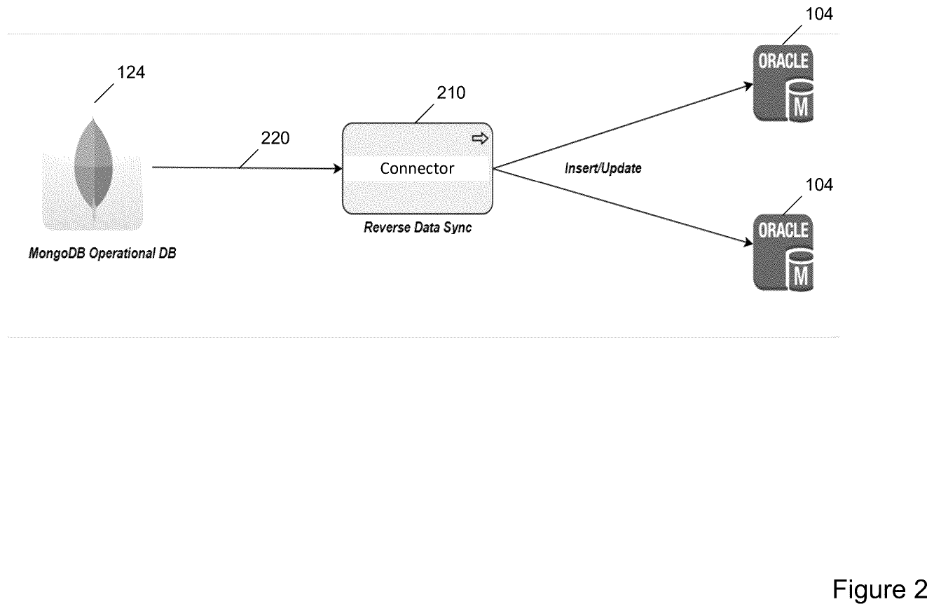

In this manner, the application 132 can be programmed to access data from one or both of the data store 104 and the data store 124. As changes are made to the data, those changes are synchronized reverse by the change propagation module 110 to assure the data store 104 and the data store 124 remain coordinated. This can allow for rolling back of data synchronization if problems are detected (e.g., by the validation module 128 described below), as provided in more detail below in reference to FIGS. 2-4. Many configurations are possible.

The validation module 128 of the change propagation module 110 is programmed to access the data in the data store 104 and the data store 124 using the transaction key. The validation module 128 can then compare the data from the data store 104 and the data store 124 to assure that the data is consistent between both data stores. The validation module 128 can report the results of this comparison to the monitoring dashboard 130.

For instance, in some examples, the validation module 128 logs any mismatched fields. The validation module 128 can be extended to reconciliation such differences and provide automated error corrections for any data in the data stores 104, 124.

The example monitoring dashboard 130 can be generated by the synchronization device 122. The monitoring dashboard 130 is programmed to provide one or more user interfaces illustrating the functionality of the synchronization device 122, such as the status of synchronization of the data from the data store 124 to the data store 124 and possible mismatches between data.

The synchronization device 122 can be programmed to handle various types of events. In one example, there are two types of events. A first type of event is a change data event, which holds the data that needs to be synchronized to the data store 104. The synchronization device 122 will use the data from the event and updates the same to the data store 104 after applying necessary transformation.

A second type of event is a change data trigger event, which holds the key identifiers of data from the data store 124. The synchronization device 122 will query the data store 124 with the key identifiers in the event, capture the actual data that needs to be synchronized from the target data store, and update the data store 104 after applying necessary transformation.

Referring now to FIGS. 2-4, additional details are provided for the reverse synchronization of data after migration. After migration occurs, the system 100 is programmed to assure that the source data store 104 remains synchronized with the target data store 124 should there be any issues associated with access to the target data store 124. This reverse synchronization can be accomplished by allowing the synchronization module 126 to capture change streams 220 generated by the target data store 124. See FIGS. 1-2.

Generally, to accomplish reverse synchronization, a reverse data sync connector 210 (e.g., an Apache Flink job), which can be implemented as part of the change propagation module 110, acts as a middle actor between the source data store 104 (legacy) and the target data store 124 (new) for data synchronization. As described above, the reverse data sync connector 210 can be programmed to consume change streams and then transform them by applying schema mappings and updates (sinks) into the source data store 104. The reverse synchronization can be configured for multiple source data stores 104, as provided in more detail below.

In this example, the reverse data sync connector 210 can be a MongoDB Connector consistent with the Apache Flink framework from the Apache Software Foundation. The reverse data sync connector 210 is programmed to listen to Mongo change streams 220 from multiple collections in an order, as the reverse data sync connector 210 processes data changes in a sequence. The reverse data sync connector 210 thereupon converts these change streams 220 into a format compatible with the legacy system, in this instance the data stores 104. The reverse data sync connector 210 is configurable to listen to multiple data stores, as provided further below.

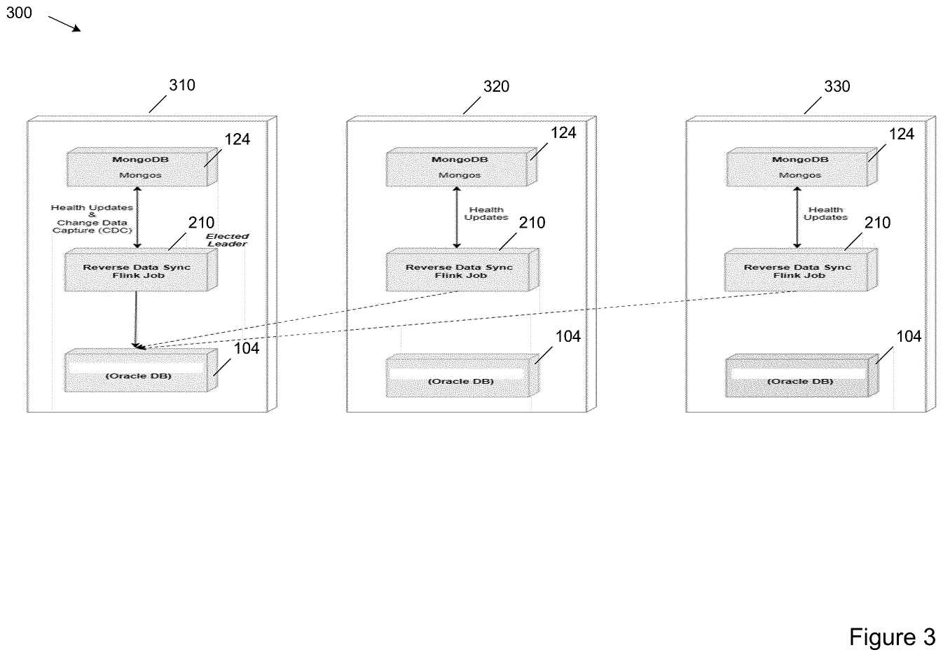

As provided in FIG. 3, the system 100 can include a plurality of data centers 300. In the example depicted, this includes data centers 310, 320, and 330, although more or fewer data centers can be provided. One or more of the data centers 310, 320, and 330 can include one or multiple source and target data stores.

An instance of the reverse data sync connector 210 is provided for the data centers 310, 320, and 330, which consumes the data changes in sequence. The data center 310 is provided as the “elected leader”, functioning as the data store for the system 100.

Should the data center 310 go down, one of the data centers 320, 330 would become the elected leader and the corresponding reverse data sync connector 210 would start processing reverse synchronization data where the data center 310 left off. Additional details are provided below.

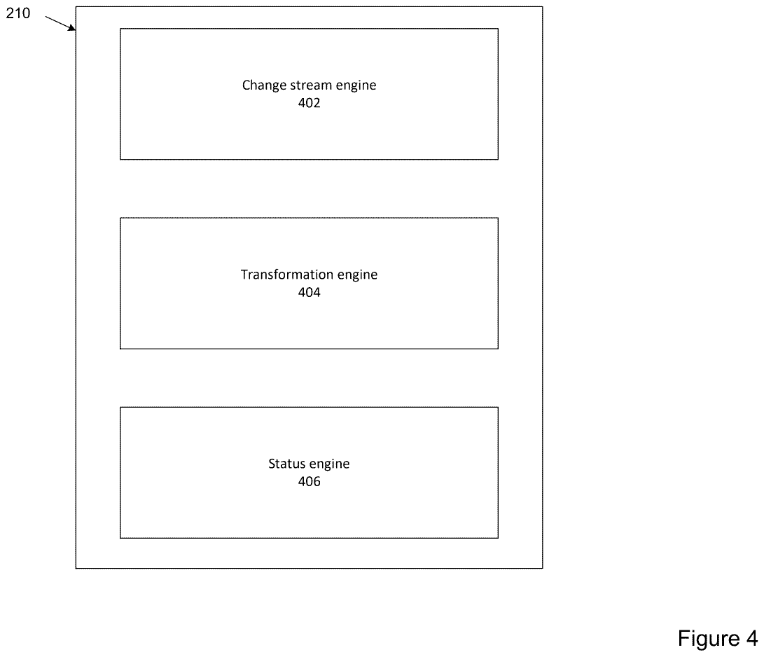

Referring now to FIG. 4, additional details of the reverse data sync connector 210 of the system 100 are shown. In this example, the reverse data sync connector 210 has various logical engines that assist in reverse synchronization. In this instance, these include a change stream engine 402, a transformation engine 404, and a status engine 406. In other examples, more or fewer engines providing different functionality can be used.

The example change stream engine 402 of the reverse data sync connector 210 is programmed to consume the change streams from the target data store 124. As previously noted, in one embodiment, the change stream engine 402 is implemented as an Apache Flink job that receives multiple change streams associated with the database operations from the data store 124. The change stream engine 402 can also filter out different collections of change streams, as desired.

The example transformation engine 404 is programmed to accept the change streams from the reverse data sync connector 210 and transform them. Specifically, the transformation engine 404 can transform the change stream into inserts or updates that are mapped to rows in the source data store 104 according to the sequence that the change stream engine 402 receives the data. This can be accomplished through various mechanisms, such as schema mappings and updates. The transformed data can thereupon be stored in the source data store 104.

Should the data center 310 become unavailable, the example status engine 406 is programed to update the leader to one of the data centers 320, 330. For instance, when the data center 310 becomes unresponsive for a period of time, such as 30 seconds, 1 minute, 5 minutes, etc., the status engine 406 can change the leader to the data center 320. The data center 320 can start processing the change stream where the data center 310 left off.

Data loss is thereby minimized or eliminated. The data center 320 can remain the leader until the data center 310 becomes available again and/or the status engine 406 changes the leader to another data center, such as the data center 330. These configurations result in redundancies that allow the system 100 to be robust should an entire data center become unavailable for a period of time.

One non-limiting example of implementation of the technology described herein follows. In this example, a legacy payment system (e.g., a consumer payment product like Zelle from Early Warning Services, LLC), uses SOAP-based web services with Oracle as the relational database. In order to transition to a microservices-based architecture, the system will use Mongo as the document-based database. The migration will also involve moving to a cloud-based system eventually. It is crucial that the customer experience remains seamless throughout this transition.

Reverse synchronization as described herein is provided as part of the migration process. The reverse data synchronization process involves consuming MongoDB Change Streams to capture changes made to documents in the database. These changes are streamed by the Mongo server and are also used by Mongo for redundancy.

An Apache Flink Job acts as an intermediary between the legacy and new systems. It consumes the stream from MongoDB change streams and applies Oracle Schema mappings and updates to the Oracle database. The mappings are configured to match the legacy system, with a one-to-one mapping of tables and columns.

The Flink job can listen to multiple collections across databases, with the ability to customize filters to exclude unwanted data, such as delete operations in MongoDB that are not relevant to the Oracle side. This reverse sync process applies to multiple Oracle databases based on the collections being monitored.

Overall, this process ensures that changes made in the MongoDB database are reflected in the corresponding Oracle databases, maintaining consistent and synchronized data between the legacy and new systems should customers need to be migrated back to the legacy system.

There are many other possible example applications of the disclosed technologies.

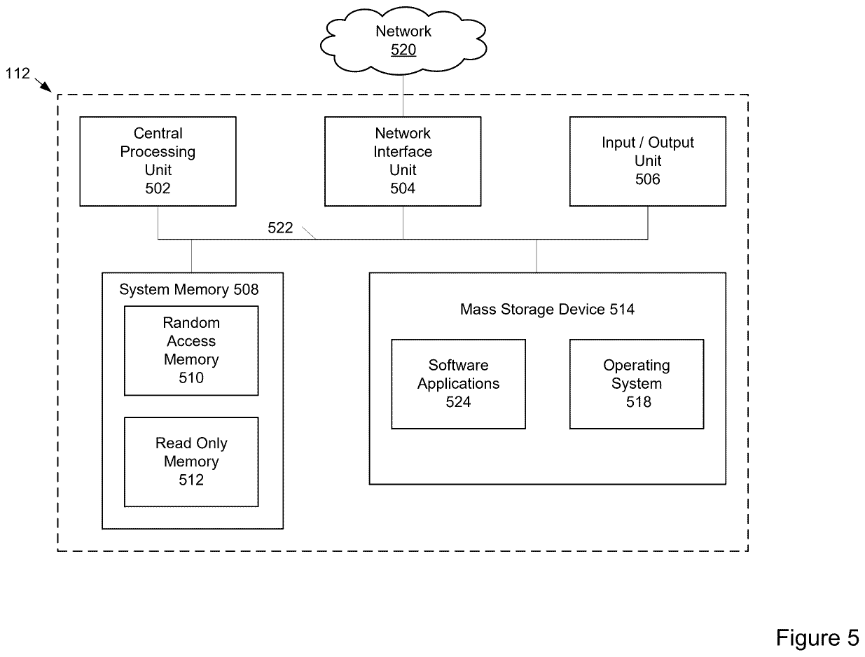

As illustrated in the embodiment of FIG. 5, the example synchronization device 122, which provides the functionality described herein, can include at least one central processing unit (“CPU”) 502, a system memory 508, and a system bus 522 that couples the system memory 508 to the CPU 502. The system memory 508 includes a random access memory (“RAM”) 510 and a read-only memory (“ROM”) 512. A basic input/output system containing the basic routines that help transfer information between elements within the synchronization device 122, such as during startup, is stored in the ROM 512. The synchronization device 122 further includes a mass storage device 514. The mass storage device 514 can store software instructions and data. A central processing unit, system memory, and mass storage device similar to that shown can also be included in the other computing devices disclosed herein.

The mass storage device 514 is connected to the CPU 502 through a mass storage controller (not shown) connected to the system bus 522. The mass storage device 514 and its associated computer-readable data storage media provide non-volatile, non-transitory storage for the synchronization device 122. Although the description of computer-readable data storage media contained herein refers to a mass storage device, such as a hard disk or solid-state disk, it should be appreciated by those skilled in the art that computer-readable data storage media can be any available non-transitory, physical device, or article of manufacture from which the central display station can read data and/or instructions.

Computer-readable data storage media include volatile and non-volatile, removable, and non-removable media implemented in any method or technology for storage of information such as computer-readable software instructions, data structures, program modules, or other data. Example types of computer-readable data storage media include, but are not limited to, RAM, ROM, EPROM, EEPROM, flash memory or other solid-state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the synchronization device 122.

According to various embodiments of the invention, the synchronization device 122 may operate in a networked environment using logical connections to remote network devices through network 520, such as a wireless network, the Internet, or another type of network. The network 520 provides a wired and/or wireless connection. In some examples, the network 520 can be a local area network, a wide area network, the Internet, or a mixture thereof. Many different communication protocols can be used.

The synchronization device 122 may connect to network 520 through a network interface unit 504 connected to the system bus 522. It should be appreciated that the network interface unit 504 may also be utilized to connect to other types of networks and remote computing systems. The synchronization device 122 also includes an input/output controller 506 for receiving and processing input from a number of other devices, including a touch user interface display screen or another type of input device. Similarly, the input/output controller 506 may provide output to a touch user interface display screen or other output devices.

As mentioned briefly above, the mass storage device 514 and the RAM 510 of the synchronization device 122 can store software instructions and data. The software instructions include an operating system 518 suitable for controlling the operation of the synchronization device 122. The mass storage device 514 and/or the RAM 510 also store software instructions and applications 524, that when executed by the CPU 502, cause the synchronization device 122 to provide the functionality of the synchronization device 122 discussed in this document.

Although various embodiments are described herein, those of ordinary skill in the art will understand that many modifications may be made thereto within the scope of the present disclosure. Accordingly, it is not intended that the scope of the disclosure in any way be limited by the examples provided.

1. A computer system for reverse synchronization of migrated data, comprising:
one or more processors; and
non-transitory computer-readable storage media encoding instructions which, when executed by the one or more processors, cause the computer system to:
consume a change stream from a target data store, the change stream including the migrated data;
transform the migrated data in the change stream between heterogeneous database formats from a target format of the target data store to a source format of a source data store;
write the migrated data in the source format in the source data store; and
switch access of a customer of the computer system from the target data store to the source data store in response to a contingency event during migration.

2. The computer system of claim 1, wherein the change stream originates from multiple target data stores.

3. The computer system of claim 1, wherein the change stream is consumed by an Apache Flink job.

4. The computer system of claim 1, wherein the change stream is converted into inserts and updates.

5. The computer system of claim 4, wherein the inserts and updates are mapped to rows in the source data store.

6. The computer system of claim 1, comprising further instructions which, when executed by the one or more processors, cause the computer system to determine a status of the reverse synchronization by the computer system.

7. The computer system of claim 6, wherein the reverse synchronization is performed by a first data center, and wherein the reverse synchronization is switched to a second data center when the first data center is down.

8. The computer system of claim 7, wherein the reverse synchronization is restored to the first data center when the first data center is back up.

9. The computer system of claim 1, comprising further instructions which, when executed by the one or more processors, cause the computer system to migrate the customer.

10. The computer system of claim 9, comprising further instructions which, when executed by the one or more processors, cause the computer system to migrate the customer from the source data store to the target data store.

11. A method for reverse synchronization of migrated data, comprising:
consuming a change stream from a target data store of a computer system, the change stream including the migrated data;
transforming the migrated data in the change stream between heterogeneous database formats from a target format of the target data store to a source format of a source data store;
writing the migrated data in the source format in the source data store; and
switching access of a customer from the target data store to the source data store in response to a contingency event during migration.

12. The method of claim 11, wherein the change stream originates from multiple target data stores.

13. The method of claim 11, wherein the change stream is consumed by an Apache Flink job.

14. The method of claim 11, wherein the change stream is converted into inserts and updates.

15. The method of claim 14, wherein the inserts and updates are mapped to rows in the source data store.

16. The method of claim 11, further comprising determining a status of the reverse synchronization by the computer system.

17. The method of claim 16, wherein the reverse synchronization is performed by a first data center, and wherein the reverse synchronization is switched to a second data center when the first data center is down.

18. The method of claim 17, wherein the reverse synchronization is restored to the first data center when the first data center is back up.

19. The method of claim 11, further comprising migrating the customer.

20. The method of claim 19, further comprising migrating the customer from the target data store to the source data store.
